(19) United States
(12) Patent Application Publication
(10) Pub. No.: US 2023/0264314 A1
(43) Pub. Date: Aug. 24, 2023

(54) METHOD OF MONITORING MACHINE PROCESSES IN WORKPLACE PROCESSING

(71) Applicant: pro-micron GmbH, Kaufbeuren (DE)

(72) Inventors: Rainer WUNDERLICH, Kaufbeuren (DE); Markus PREUSS, Kempten (DE)

(73) Assignee: pro-micron GmbH, Kaufbeuren (DE)

(21) Appl. No.: 18/171,807

(22) Filed: Feb. 21, 2023

(30) Foreign Application Priority Data
Feb. 21, 2022 (EP) 22157816.4

(51) Int. Cl. B23Q 17/09; G06F 30/20

(52) U.S. Cl. CPC B23Q 17/099; G06F 30/20; G06F 2119/18

(57) ABSTRACT

A method for monitoring machining processes in workpiece processing including steps of planning a processing process on the basis of a predetermined final shape of a workpiece to be achieved in the processing process and of quality features of the final shape of the workpiece and simulating the planned processing process in a computer-aided simulation. Target values of parameters of the simulated processing process occurring during the simulated processing process are detected and stored in the context of the computer-aided simulation. During the real processing process carried out according to the planned and simulated processing process, the parameters considered in the simulation are monitored and the actual values thereof are detected. By comparing actual values of parameters detected during the real processing process with the target values of these parameters detected during the simulation, the quality of the processing process and/or of the processed workpiece is assessed.

### TECHNICAL FIELD

The invention relates to a method for monitoring machining processes in workpiece processing.

### BACKGROUND ART

Machining still represents one of the most important forms, if not the most important form, of manufacturing processing. For example, a large number of workpieces made of a wide variety of materials, such as metal, plastic, or composite material, are produced by milling or turning, and are frequently also finished by grinding. This applies equally to workpieces of small size such as gear wheels of gearboxes, as well as to workpieces of a considerable size such as turbine blades or the like. Machining is used both in series production and in the processing of workpieces in small batches or also in single part production. Quality monitoring and control is a particular aspect that has gained increasing importance and is still gaining importance.

When planning a machining process to be carried out on a machine tool, such as in particular a milling, turning or grinding machine, planning software is generally used for the scheduling and programming of the machine tool. In this case, design data, which are commonly files exported from the design programs, are read into such planning software, in which the processing process can then be planned. In this case, in particular tool paths on the workpiece surface are planned in order to find a processing profile which reliably prevents tool collisions with the workpiece, but which also allows safe and reliable processing of the workpiece in a processing time which is as efficient as possible. In this case, for example, emphasis can be placed on uniformly cut profiles which produce a high surface quality of the processed workpiece, or also on closely disposed cutting paths on particularly critical workpiece portions, in order to obtain locally strong and stable workpieces.

In order now to verify a processing sequence obtained in the context of such a planning process in practice, with regard to a quality of the processing result obtained, and to obtain a basis for the monitoring of the processing process, reference pieces are now processed in practice on the machine tools on the basis of the planned processing sequence, and the quality of the reference pieces is assessed and parameters of the processing sequence, such as the power consumption of the spindle motor of a workpiece spindle, are detected and stored during the processing of the reference piece. These values are then taken as reference values in the following real processing processes in which the actual workpiece is processed and are compared with the values of the parameters detected during the actual processing process. If the values correspond within a previously defined tolerance range, a processing process carried out in accordance with the target specifications and a good-quality result of the processed workpiece are inferred.

However, this procedure is complicated since it initially requires processing a reference piece and recording the values of the parameters detected in the process as target values. In addition, the creation of a reference piece is in particular a cost-determining factor when subsequently only a small batch of workpieces is to be processed or even only a single workpiece is to be processed within the context of single part production.

### SUMMARY OF THE INVENTION

The object of the invention is now to provide a possibility of monitoring processing processes in workpiece machining without having to resort to the processing of a reference piece.

This object is achieved according to the invention by a method having the features of planning a processing process on the basis of a predetermined final shape of a workpiece to be achieved in the processing process and of quality features of the final shape of the workpiece to be obtained, and simulating the planned processing process in a simulation carried out in a computer-aided manner. Target values of parameters of the simulated processing process occurring during the simulated processing process are detected and stored in the context of the computer-aided simulation. During the real processing process carried out according to the planned and simulated processing process, the parameters considered in the simulation are monitored and the actual values thereof are detected, and by comparing the actual values of the parameters detected during the real processing process with the target values of these parameters detected during the simulation, the quality of the processing process and/or of the processed workpiece is assessed. Advantageous developments of the invention include that the method may be characterized in that compliance of the processed workpiece with the quality specifications may be determined in the case of correspondence, within a tolerance range, of the actual values of the parameters determined during the real processing process (III) with the target values of the parameters determined during the simulation (I). The method may further be characterized in that as parameters of the processing process, forces and/or bending moments occurring on a processing tool acting on the workpiece during the processing process, and/or torques and/or power consumption of axis or spindle motors of a machine tool executing the processing process and/or accelerations and/or vibrations and/or generated structure-borne sound may be observed and the target values thereof in the simulation and actual values during the real processing process are detected and compared. The method may further be characterized in that the detection of the target values of the parameters in the simulation and the detection of the actual values of the parameters during the real processing process may be resolved according to location and/or time. The method may further be characterized in that the comparison may be carried out in a computer-aided manner and in real time. The method may further be characterized in that in the case of a determined deviation, exceeding a tolerance threshold, of the actual values of at least one of the parameters from the target values of the at least one parameter, the processing process may be paused or stopped, optionally after completion of a currently executed partial processing step. The method may further be characterized in that the actual values of the parameters detected during the real processing process may be stored together with the target values of the parameters detected during the simulation in a processing protocol assigned to the workpiece processed in the real processing process.

According to the invention, a method for monitoring machining processes in workpiece processing comprises the following steps:
a. A processing process is planned on the basis of a predetermined final shape of a workpiece to be achieved in the processing process and of quality features of the final shape of the workpiece to be obtained.
b. The planned processing process is simulated in a simulation carried out in a computer-aided manner. This typically takes place using a simulation program, which in particular also factors in the type and design and the relevant operating parameters of the machine tool and the type and design of the processing tool used.
c. In the context of the simulation carried out in a computer-aided manner, target values of parameters of the simulated processing process occurring during the simulated processing process are detected and stored. In this case, sensors and measuring detectors used in particular on the real machine tool can also be represented in simulation software used, so that the values of the parameters can be detected during the simulation using the sensors and measuring detectors which are virtually present there.
d. During the real processing process carried out according to the planned and simulated processing process, the parameters considered in the simulation are monitored and the actual values thereof are detected. In this case, the real sensors and measuring detectors are typically used which are also mirrored in the simulation software for the virtual machine tool.
e. Finally, by comparing the actual values of the parameters detected during the real processing process with the target values of these parameters detected during the simulation, the quality of the processing process and/or the processed workpiece is assessed.

With such a procedure, it is possible to completely carry out the monitoring and also the checking of the processing process in terms of the quality of a processing result without the requirement of creating a reference piece. Instead, only virtually obtained simulation data are used. For this purpose, it is then only necessary, in a simulation, to virtually carry out the process planned in the previous step according to the planning on a virtual machine tool reproduced in the simulation of the real machine tool using a virtual tool which is reproduced in accordance with the real tool, and in the process to detect, by means of virtual sensors and virtual measuring detectors reproduced according to the sensors and measuring detectors actually present on the machine tool, the values of predetermined parameters detected during the simulated machining of the virtual workpiece as target values, in order then to compare said values actual values detected using the real sensors and the real measuring detectors in a real processing process subsequently with the carried out in accordance with the planning and to carry out an evaluation of the process result on the basis of the comparison.

The above-mentioned simulation also has the advantage that, in the course of such a simulation, a check of the planned processing process can be carried out in respect of a result quality. This is because if it is ascertained that the target values detected in the context of the simulation lead to a poor result of the workpiece, e.g., because fluctuations of values are detected which indicate problems in tool engagement, the planning of the processing process can be revised and can be entered once again into the simulation with the newly planned processing process in order to then determine new target values.

In the context of this evaluation, compliance of the processed workpiece with the quality specifications can be determined, in particular in the case of correspondence, within a tolerance range, of the actual values of the parameters determined during the real processing process with the target values of the parameters determined during the simulation. A visual inspection of the finished workpiece can even be omitted.

As parameters of the processing process, forces and/or bending moments occurring on a processing tool acting on the workpiece during the processing process can be used, in particular as can be measured during machining processes, for example with a sensory tool holder, for example with a tool holder provided by the applicant under the brand name SPIKE®.

Alternatively or also additionally, torques and/or power consumption of axis or spindle motors of a machine tool carrying out the processing process can also be considered to be parameters.

As parameters, accelerations and/or vibrations and/or generated structure-borne sound acting on the processing tool can also be used.

The bending moments that act on the processing tool during the machining process have been found to be particularly suitable since they provide very precise indications, with other parameters, such as the above mentioned, also being possible.

Advantageously, the detection of the target values of the parameters in the simulation (step c) and the detection of the actual values of the parameters during the real processing process (step d) can take place in a manner resolved by location and/or time. This then allows an exact assignment of a deviation of the actual values from the target values and of a resulting processing sequence deviating from the specification to a position on the workpiece and/or to a time of the processing. In the case of a spatially and/or resolved detection of the target values and of the actual values, a representation of the workpiece in its final form which develops with the processing time can be displayed on a display device, for example a computer screen, in which representation, for example, the deviation of the actual values from the target values is indicated in false colors. Such a representation allows a machine operator to make a very fast and simple visual inspection of the current process. For this purpose, but not solely for this purpose, the comparison in step e can advantageously take place in a computer-aided manner and in real time, so that real time monitoring is possible. However, a comparison of the actual values with the target values can also take place downstream after the processing process, in order to subsequently assess the quality of the work result.

The method according to the invention can also provide that, in the case of a determined deviation, exceeding a tolerance threshold, of the actual values of the at least one parameter from the target values of the at least one parameter, the processing process is paused or stopped. In this way, a processed workpiece can be further processed, if necessary after an adjustment of the hardware or the machine controller of the machine tool, e.g., after the replacement of a worn tool, without the workpiece being considered as scrap. If the workpiece currently being processed can no longer be further processed, pausing or stopping of the processing process is advantageous in any case to the extent that no further processing takes place which wastes time and resources and therefore results in further costs. The pausing or stopping can take place directly with the determination of a deviation exceeding the tolerance threshold. However, it can also be provided that a currently executed partial processing step is initially finished and the process is only subsequently paused or stopped. For example, a tool can be protected which could otherwise be damaged in the event of abrupt stopping. It is also possible to prevent a workpiece from having, due to abrupt stopping, such processing tracks as would prevent its further use.

The tolerance threshold designated above can in particular be determined by a predetermined extreme value for the entire processing process.

However, it can also be defined alternatively or additionally in a position-dependent and/or time-dependent manner for any number of values, even with deviating parameters.

In addition, the actual values of the parameters detected in step d during the real processing process can advantageously be stored together with the target values of the parameters detected in step c during the simulation in a processing protocol assigned to the workpiece processed in the real processing process. In this way, a quality document associated with the workpiece is obtained. Such documentation is required in various sectors by the purchasers of the workpieces in order to be able to assess, for example, in the event of any errors and defects of the workpieces, on the basis of such documentation, whether errors could have occurred during production.

### BRIEF DESCRIPTION OF THE DRAWINGS

In the following, a procedure according to the method according to the invention is explained once again in the context of a possible embodiment described on the basis of the accompanying figures. In the drawings:

FIG. 1 schematically shows a sequence of the method with the simulation, the recording of the parameters during the simulation, a definition of a tolerance range and the subsequent measurement of the parameters in the real process with associated evaluation in comparison with the parameters detected in the simulation; and

FIG. 2, in representations a to c, illustrates examples of a real profiles of a parameter deviating from the specification as an indicator of a process profile not corresponding to the specifications.

### DETAILED DESCRIPTION

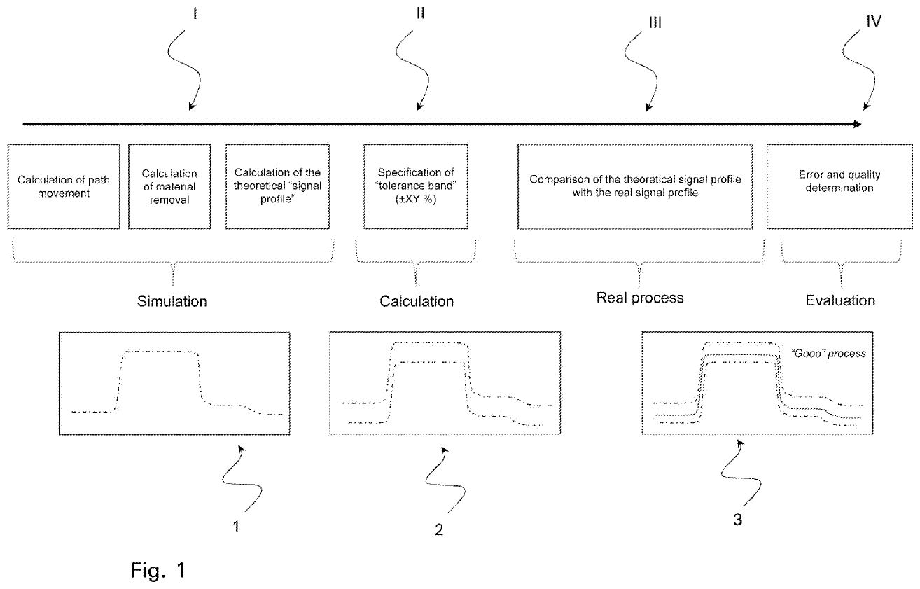

FIG. 1 schematically shows as an example a sequence for a method according to the invention for monitoring machining processes in workpiece processing on the basis of a possible design variant. A solid arrow in the upper part of the figure symbolizes a timeline and indicates that the steps denoted by Ito IV, described in more detail below, lie in temporal succession in a manner explained in more detail below.

A processing process, which has been planned beforehand on the basis of a predetermined final shape of a workpiece to be achieved in the processing process and of quality features of the final shape of the workpiece to be obtained, is simulated in a computer-assisted manner in the portion denoted by I. In this case, path movements are calculated which are carried out by a tool relative to the workpiece, and which are obtained in practice by a movement of the workpiece and/or of the tool. Furthermore, during the simulation, the material removal is calculated, which, starting from a blank form of the workpiece, takes place along the respective traversed paths in a manner resolved according to location and time. From the data calculated in this way, it is then possible, on the basis of the movement coordinates of the tool relative to the workpiece and the thickness of the material to be respectively removed along the path, to determine value profiles of predeterminable parameters as target values, taking into account the material properties, which values can then be recognized as theoretical signal profiles of sensors which detect the values of the parameters. This can be, for example, a signal profile for a bending moment acting on the tool or a tool holder. However, other parameters are also conceivable, such as forces or moments applied to the tool or also torque or power consumption of spindle motors for tool drives and/or workpiece drives or the like, the signal profiles of which are simulated.

FIG. 1 shows by way of example a profile of the simulated value of a parameter, plotted over time, for example, in a dashed line in the window provided with the reference sign 1. Instead of plotting over time, plotting depending on the location can also be provided here, for example. A resolution of data according to location and time is equally conceivable.

In a following step, denoted by II in FIG. 1, a tolerance band is defined here within the scope of a calculation, in this exemplary embodiment by a percentage deviation of ±XY %, wherein XY indicates a value which is suitable for the process and which is determined by the person skilled in the art on the basis of their experience, possibly based on simple experiments. Accordingly, in the representation in the window provided with reference sign 2, two dashed lines can be seen, of which a lower line indicates the profile of a lower limit value of the tolerance window, and an upper line indicates the profile of an upper value of the tolerance window. This simulation and calculation can, in particular, also be defined once for performing a large number of processing processes to be carried out, for example in batch production. However, these steps can also be carried out for a single subsequent individual processing process.

Furthermore, FIG. 1 shows the already mentioned processing process, which is referred to here as a real process and which takes place in the portion designated by III. In the context of this process, the profile of the parameter which was previously determined in the simulation as a simulated parameter for the comparison is detected as an actual value.

In the context of an evaluation, which is illustrated in the sequence shown in FIG. 1 at IV, the profile of the actual value of the parameter detected by means of sensors in the real processing process is compared with the possible profile of the target value determined by specifying the tolerance band. This evaluation can take place downstream of the processing process, i.e., in a temporally decoupled manner. However, it can also be carried out in situ while the processing process is being carried out. FIG. 1 shows, in the window designated by 3, a result in which the profile of the actual value of parameter shown in a solid line and determined by means of the suitable sensors lies within the tolerance band determined by the two dashed lines, previously determined in the step described under II, so that the real process carried out is evaluated as “good” and corresponding to expectations or specifications. The data or profiles as shown in window 3 can in particular be stored and associated with and assigned to the processed workpiece as a processing protocol.

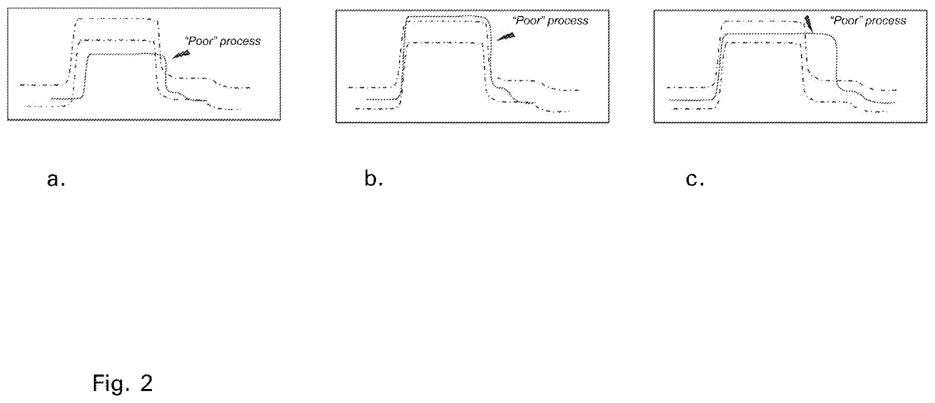

FIG. 2 shows, in three different representations a, b and c, the profiles of the actual value (in each case in a solid line) determined by sensors with respect to the tolerance band previously determined under step II (the two dashed-line profiles), in which the profile of the actual value of the parameter lies at least partially outside the specified tolerance band, so that the process carried out in each case is evaluated as not complying with the specifications and thus as “poor.” If such a determination occurs in the context of the evaluation, the current process can in particular be paused in order to determine a cause for the deviation from the values predetermined by the simulation and to readjust the process or the processing machine in order to again obtain an evaluation which corresponds to the specifications and is recognized in the result of the evaluation as in FIG. 1 in the window designated by 3, and thereby to obtain a processing of the workpiece in the machining process qualitatively corresponding to the specifications.

It is again illustrated by the above description that the method according to the invention can be used to carry out monitoring of a machining process that can dispense with an analysis of the finished workpiece, for example in the context of a complex measurement, in that it only performs a comparison of simulation data for the determined parameter, in the form of target values, with the actual values determined during the real processing for these parameters, and identifies and confirms the consistent quality of the processing in the event of correspondence within a tolerance range, while, on the other hand, identifying an error and a possible quality deficiency in the case of a deviation.

The above description of the exemplary embodiment shown is again used to illustrate and explain the invention and its advantages, without describing all possible embodiments of the invention, as defined in the following claims, for example.

1. A method for monitoring machining processes in workpiece processing, comprising steps of:
a. planning a processing process on the basis of a predetermined final shape of a workpiece to be achieved in the processing process and of quality features of a final shape of the workpiece to be obtained;
b. simulating the planned processing process in a simulation carried out in a computer-aided manner;
c. detecting and storing target values of parameters of the simulated processing process occurring during the simulated processing process in a context of the computer-aided simulation;
d. during the real processing process carried out according to the planned and simulated processing process, monitoring the parameters considered in the simulation and detecting the actual values thereof; and
e. assessing the quality of the processing process or the processed workpiece by comparing the actual values of the parameters detected during the real processing process with the target values of these parameters detected during the simulation.

2. The method according to claim 1, wherein compliance of the processed workpiece with quality specifications is determined in the case of correspondence, within a tolerance range, of the actual values of the parameters determined during the real processing process with the target values of the parameters determined during the simulation.

3. The method according to claim 1, wherein as parameters of the processing process:
forces or bending moments occurring on a processing tool acting on the workpiece during the processing process, or
torques or power consumption of axis or spindle motors of a machine tool executing the processing process; or
accelerations or vibrations or generated structure-borne sound,
are observed and the target values thereof in the simulation and the actual values during the real processing process of step d are detected and compared in step e.

4. The method according to claim 1, wherein the detection of the target values of the parameters in the simulation of step c and the detection of the actual values of the parameters during the real processing process of step d are resolved according to location and/or time.

5. The method according to claim 1, wherein the comparison in step e is carried out in a computer-aided manner and in real time.

6. The method according to claim 5, wherein, in the case of a determined deviation, exceeding a tolerance threshold, of the actual values of at least one of the parameters from the target values of the at least one parameter, the processing process is paused or stopped.

7. The method according to claim 1, wherein the actual values of the parameters detected in step d during the real processing process are stored together with the target values of the parameters detected in step c during the simulation in a processing protocol assigned to the workpiece processed in the real processing process.

8. The method according to claim 6, wherein the processing process is paused or stopped after completion of a currently executed partial processing step.
